(19) United States
(12) Patent Application Publication
(10) Pub. No.: US 2022/0117369 A1
(43) Pub. Date: Apr. 21, 2022

(54) HAIR TIE EXTRACTION IMPLEMENT

(71) Applicant: Lauren Peterson, Lehi, UT (US)

(72) Inventor: Lauren Peterson, Lehi, UT (US)

(21) Appl. No.: 17/562,564

(22) Filed: Dec. 27, 2021

Related U.S. Application Data
(63) Continuation of application No. 16/442,340, filed on Jun. 14, 2019, now Pat. No. 11,206,908.
Application No. 16/442,340 is a continuation-in-part of application No. 15/378,349, filed on Dec. 14, 2016, now abandoned.

(51) Int. Cl. A45D 8/00; A46B 9/02; A46B 15/00; B26B 11/00

(52) U.S. Cl. CPC A45D 8/00; A46B 9/023; A45D 8/002; B26B 11/00; A46B 2200/104; A46B 15/0065

(57) ABSTRACT

Described herein are examples of an apparatus. The apparatus includes a grippable portion, a hook, a blade, and a blade recess. The hook extends from the grippable portion. The hook includes interior and exterior surfaces. The interior surface is proximate the grippable portion. The interior surface extends away from the grippable portion to form a blade recess between the hook and the grippable portion. The exterior surface is distal to the grippable portion and converges with the interior surface to form a hook. The blade recess is formed between the hook and the grippable portion. The blade recess has a curved apex where the interior surface of the hook meets the grippable portion. The blade is integrated within the blade recess to be proximate the curved apex of the blade recess with a sharpened edge of the blade facing away from the curved apex of the blade recess.

### CROSS-REFERENCE TO RELATED APPLICATIONS

The present application is a continuation of U.S. Non-Provisional patent application No. 16/442,340 entitled “HAIR TIE EXTRACTION IMPLEMENT”, filed on 14 Jun. 2019. The entire contents of the above-listed application are hereby incorporated by reference for all purposes.

### BACKGROUND

Hair ties are well-known in the art for styling the hair of younger children and women. Elastomeric bands (i.e., rubber bands), which are often fabricated for application as office supplies, are the cheapest and most commonly used hair ties among children. Guardians, parents, caretakers, and/or the children themselves stretch and twist these elastomeric bands around locks of hair for utilitarian or ornamental function, using the elastomeric bands to form ponytails, buns, braids, and other hairstyles known to those of skill in the art.

Although elastomeric bands are easily manipulated to style hair, they are much less easily extracted from the styled hair. The hair itself becomes entangled with the elastomeric bands and often the elastomeric bands cannot be readily removed by hand without pulling the hair of the wearer, causing children to leave the elastomeric bands in their hair unnecessarily. They hair ties embedded in hair styles eventually pulling large amounts of hair from the scalp when left in place while also causing discomfort.

There exists no means in the art of painlessly extracting elastomeric bands or hair ties from hair. Knives and scissors are not effective because they cannot be isolated during cutting to the hair tie itself and because they cannot Because the elastomeric bands can be purchased in bulk for very little cost, there is no incentive to preserve them after use for subsequent use. There is a need in the art for an elastomeric band extraction implement adapted to cut and remove elastomeric bands and hair ties from the hair without cutting or damaging the hair itself.

### BRIEF DESCRIPTION OF THE DRAWINGS

The present description will be understood more fully when viewed in conjunction with the accompanying drawings of various examples of hair tie extraction implements. The description is not meant to limit the hair tie extraction implements to the specific examples. Rather, the specific examples depicted and described are provided for explanation and understanding of hair tie extraction implements. Throughout the description the drawings may be referred to as drawings, figures, and/or FIGs.

FIG. 1A is a side perspective view of a hair tie extraction implement according to an embodiment;

FIG. 1B is a side perspective view of a hair tie extraction implement according to an embodiment;

FIG. 2 is a top perspective view of a hair tie extraction implement according to an embodiment;

FIG. 3 is a lower perspective view of a hair tie extraction implement according to an embodiment;

FIG. 4 is a forward perspective view of a hair tie extraction implement according to an embodiment;

FIG. 5A is an environmental perspective view of a hair tie according to an embodiment;

FIG. 5B is an environmental perspective view of a hair tie according to an embodiment;

FIG. 5C is an environmental perspective view of a hair tie and hair extraction implement according to an embodiment;

FIG. 5C is an environmental perspective view of a hair tie and hair extraction implement according to an embodiment;

FIG. 6 is a side perspective view of a hair tie extraction implement according to an embodiment;

FIG. 7 is a side perspective view of a hair tie extraction implement according to an embodiment; and

FIG. 8 is a bottom perspective view of a hair tie extraction implement according to an embodiment.

### DETAILED DESCRIPTION

Hair tie extraction implements as disclosed herein will become better understood through a review of the following detailed description in conjunction with the figures. The detailed description and figures provide merely examples of the various embodiments of hair tie extraction implements. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

The present invention has been developed in response to the present state of the art, and in particular, in response to the problems and needs in the art that have not yet been fully solved by currently available. Accordingly, the present invention has been developed to provide a hair tie extraction implement adapted to cut elastomeric bands from hair, the hair tie extraction implement comprising: an elongated grippable shank; a U-shaped hook affixed to the shank having an interior surface, an apex and an exterior surface, the U-shaped hook defining a tapering blade recesses adapted to receive a hair tie; an outwardly rising bill affixed to a terminal end of the hook, the bill adapted to insert into strands of hair; and a polymeric razor blade affixed to the interior surface of the hook, the razor blade oriented such that a sharpened edge faces away from the apex of the hook.

The shank, hook and blade may be formed as a single integrated piece. The hair tie extraction implement may be adapted to be used as a keychain. The hair tie extraction implement may comprise one of titanium, aluminum and steel. A length of the hair tie extraction implement may be less than three inches in some embodiments.

The hair tie extraction implement may further comprise an edge guard disposed above the sharpened edge of the crook. The hair tie extraction implement may further comprise a plurality of protruding bristles forming a brush.

The handle may further comprise a recess for receiving the brush.

The bristles of the handle may cantilever laterally from the handle.

A second hair tie extraction implement adapted to cut elastomeric bands from hair is provided, the hair tie extraction implement comprising: an elongated grippable shank; a U-shaped hook affixed to the shank having an interior surface, an apex and an exterior surface; an outwardly rising bill affixed to a terminal end of the hook, the bill adapted to insert into strands of hair; and a razor blade affixed between to the interior surface of the hook, the razor blade oriented such that a sharpened edge faces away from the apex of the hook; the razor blade forming a chord within a circular shape of the hook.

The shank, blade and hook may be formed as a single integrated piece.

The hair tie extraction implement may be adapted to be used as a keychain.

The hair tie extraction implement may comprise one of titanium, aluminum and steel.

A length of the hair tie extraction implement may be less than three inches.

The hair tie extraction implement may further comprise an edge guard disposed above the sharpened edge of the crook.

The blade may be inwardly-curving, or concave.

A third hair tie extraction implement adapted to cut elastomeric bands from hair is provided, the hair tie extraction implement consisting of: an elongated grippable shank; a plurality of bristles forming a brush, the bristles protruding from the handle; a U-shaped, polymeric hook affixed to the shank having an interior surface, an apex and an exterior surface, the U-shaped hook defining a tapering blade recesses adapted to receive a hair tie; an outwardly rising bill affixed to a terminal end of the hook, the bill adapted to insert into strands of hair; wherein an interior surface of the hook is sharpened to form a blade facing the brush; and wherein the handle, hook, bill and blade are formed as a single integrated, polymeric piece.

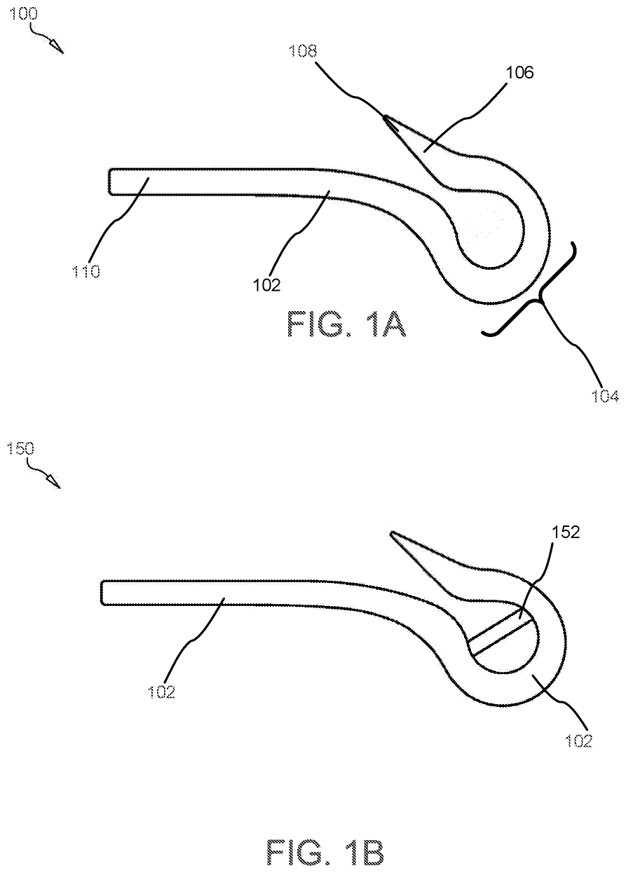

FIG. 1A is a side perspective view of a hair tie extraction implement in accordance with the present invention. The implement 100 comprises a shank 102, a proximal end 110, and a hook 104 comprising an outward bill 106 comprising a tip 108.

The implement 100 is adapted to insert into a lock of hair and separate strands of hair surrounding a hair tie.

The bill 106 is inserted first with the tip 108 leading. The bill 106 protrudes upwardly and outwardly from the hook 104.

The shank 102 and hook 104 may be formed as a single integrated piece. The shank 102 may comprise an elongated cylindrical or tubular metallic, metal alloy, organic or polymeric member. The shank 102 and hook 104 may comprise a pipe, tube shaft, bar, rod or any other component known to those of skill in the art. The shank 102 may comprise an extruded aluminum, steel or titanium rod.

The hook 104 is affixed to the shank 102 such that an opening defined by the hook 104 sits above the shank 102.

FIG. 1B is a side perspective view of a hair tie extraction implement in accordance with the present invention.

The razor blade 152 is adapted to engage a hair tie and severe it when the implement 100 is pulled or compressive force is applied to the hair tie. The razor blade 152 comprises one or more sharpened edges. At least one of those sharpened edges faces forward toward the proximal end 110 of the implement 150.

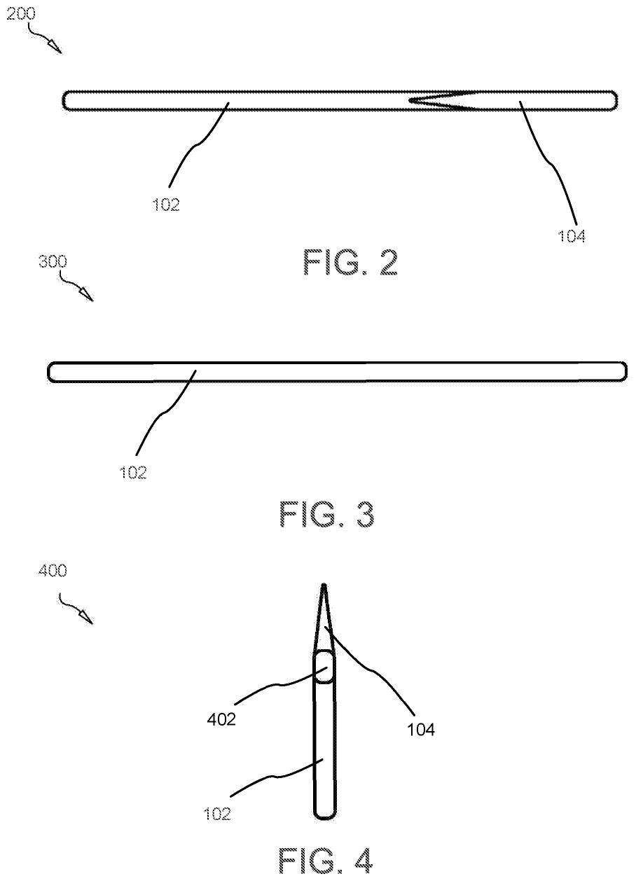

FIG. 2 is a top perspective view of a hair tie extraction implement in accordance with the present invention.

FIG. 3 is a lower perspective view of a hair tie extraction implement in accordance with the present invention.

FIG. 4 is a forward perspective view of a hair tie extraction implement in accordance with the present invention.

The shank 102 must be angled downward from a forward perspective to expose the open hook end 402.

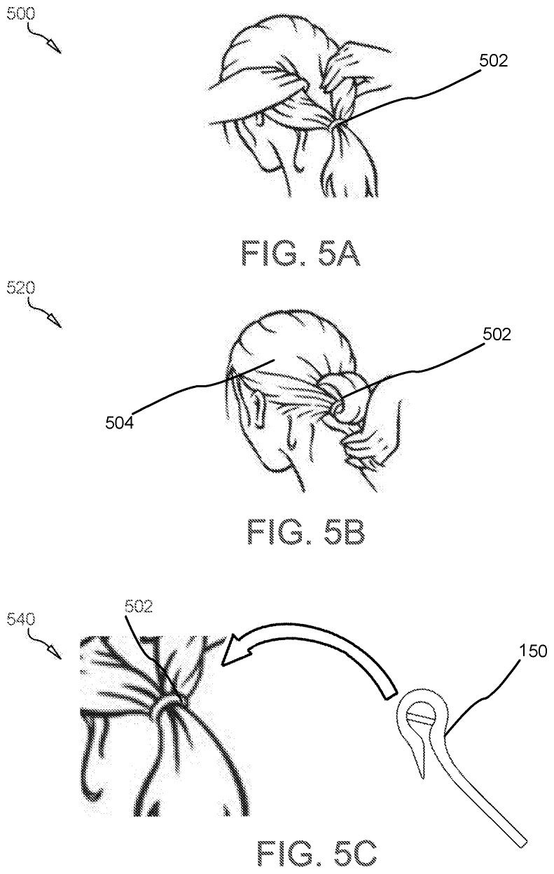

FIG. 5A is an environmental perspective view of a hair tie in accordance with the present invention.

The hair tie 502 may comprise any hair tie known to those of skill in the art, including an elastomeric band (“rubber band”).

FIG. 5B is an environmental perspective view of a hair tie in accordance with the present invention.

The hair tie 502 may become entangled with surrounding hair when hair is wound over the hair tie 502.

FIG. 5C is an environmental perspective view of a hair tie and hair extraction implement in accordance with the present invention.

The bill of the implement 150 is inserted in inverted position into hair 504 above the hair tie 502. The hook of the implement 150 follows the bill into the hair and the hair tie 502 is hooked by the implement than severed by the razor blade housed within the hook when the downward compressive force is applied using the implement 150.

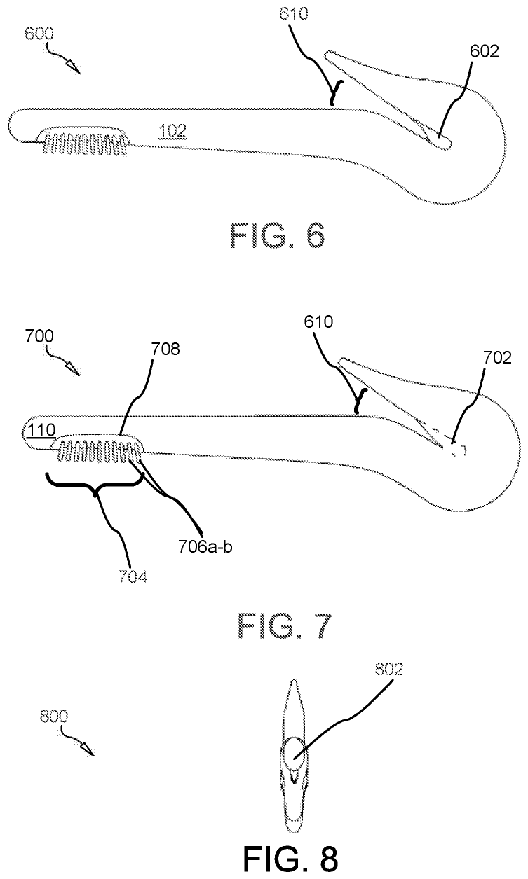

FIG. 6 is a side perspective view of a hair tie extraction implement 600 in accordance with the present invention.

The apparatus 600, as shown, comprises a blade 602 which is concave along its sharpened edge, which edge faces the brush 704 (shown below). The blade 602 is curved inward to allow axial motion of the apparatus 600 with respect to a hair tie, improving cutting function. This curved blade also help prevent injury to small children's fingers which may press through the blade recess 610 and come in contact with the blade 602. The blade recess is between 0.5 and 10 millimeters wide, and tapers toward the blade, reducing in width to 10% to 80% of its original width.

FIG. 7 is a side perspective view of a hair tie extraction implement 700 in accordance with the present invention.

The apparatus 700 has handle 102 and proximal end 110. The handle 102 and/or proximal end 110 define a recess 708 as shown in some embodiments to receive a brush 704 comprising a plurality of protruding rigid bristles 706. The bristles 706 may protrude laterally from the handle 102 as shown or may protrude superiorly or inferiorly thereto.

In some embodiments, the blade 702 is not made from steel, metal, or a metal alloy but rather in fabricated from polymeric materials as the handle 102 and hook 104. The blade 702 may be formed from a hardened plastic which is then sharpened to impart function to the apparatus 700 before being inserted, sharpened after insertion, or formed with a sharpened edge in the mold.

In various embodiments, the blade 702 is formed as a single integrated piece with the handle 102 and hook 104.

FIG. 8 is a bottom perspective view of a hair tie extraction implement 800 in accordance with the present invention.

In various embodiments, the proximal end 110 of the handle 102 is bulbous 802 as shown to facilitate gripping.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. An apparatus, comprising:
a grippable portion;
a hook extending from the grippable portion, wherein the hook comprises:
an interior surface proximate the grippable portion, the interior surface extending away from the grippable portion to form a blade recess between the hook and the grippable portion; and
an exterior surface of the hook distal to the grippable portion and converging with the interior surface to form a hook tip shaped to insert between strands of hair and capture, from the hair, a hair elastic within the blade recess;
the blade recess formed between the hook and the grippable portion, the blade recess having a curved apex where the interior surface of the hook meets the grippable portion; and
a blade integrated within the blade recess to be proximate the curved apex of the blade recess with a sharpened edge of the blade facing away from the curved apex of the blade recess.

2. The apparatus of claim 1, wherein the grippable portion and the hook are formed as a single monolithic piece.

3. The apparatus of claim 1, wherein the grippable portion, the hook, and the blade form a single integrated piece.

4. The apparatus of claim 1, wherein at least one of the grippable portion, the blade, or the hook is formed of:
titanium;
aluminum; or
steel.

5. The apparatus of claim 1, wherein the blade is formed of a material that is different from a material of at least one of the hook or the grippable portion.

6. The apparatus of claim 1, wherein the exterior surface of the hook and the interior surface of the hook converge to one another uniformly over a length of the hook.

7. The apparatus of claim 1, wherein the grippable portion includes a bulbous geometry to facilitate gripping.

8. The apparatus of claim 1, wherein the blade forms a chord with the sharpened edge extending between the grippable portion and the interior surface of the hook.

9. The apparatus of claim 1, wherein the blade recess tapers toward the blade.

10. The apparatus of claim 1, wherein the blade recess tapers uniformly along a length of the hook.

11. The apparatus of claim 1, wherein a segment of the interior surface of the hook is planar along at least one dimension.

12. The apparatus of claim 1, wherein the blade forms an acute angle relative to at least one of the hook and the grippable portion.

13. The apparatus of claim 1, wherein the blade is metallic or polymeric.

14. The apparatus of claim 1, wherein the grippable portion varies in width along a length of the grippable portion.

15. An apparatus, comprising:
a grippable portion;
a hook extending from the grippable portion, the hook comprising:
a blade recess defined by the hook relative to the grippable portion, the blade recess having a geometry between the hook and the grippable portion that tapers towards a curved apex of the blade recess, wherein the blade recess is adapted to receive a hair tie;
a blade affixed between the grippable portion and the hook within the blade recess, wherein:
the blade is embedded in a material of the hook and the grippable portion and oriented such that a sharpened edge of the blade faces away from the curved apex of the blade recess; and
the blade forms a chord within the blade recess of the hook.

16. The apparatus of claim 15, wherein the blade forms the chord within the hook such that the blade is approximately perpendicular to an interior surface of the hook.

17. The apparatus of claim 15, wherein a thickness of a segment of material that forms the hook is approximately the same as a thickness of the grippable portion.

18. An apparatus, comprising:
a grippable portion; and
a hook extending from the grippable portion, the hook having an interior surface, an apex, and an exterior surface, and the hook defining a blade recess adapted to receive a hair tie;
wherein:
a blade is positioned within the blade recess to extend between the hook and the grippable portion and face away from the apex of the blade recess of the hook; and
the grippable portion and the hook are formed as a single integrated, polymeric piece.

19. The apparatus of claim 18, wherein the blade recess forms a curved apex proximate the blade.

20. The apparatus of claim 18, wherein the blade comprises a metal formed into a material of the hook and the grippable portion.
